(19) United States
(12) Patent Application Publication
(10) Pub. No.: US 2006/0158608 A1
(43) Pub. Date: Jul. 20, 2006

(54) Eyeglasses with signal receiving function

(76) Inventor: Chung-Hung Lin, Syuejia Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/037,373

(22) Filed: Jan. 19, 2005

(51) Int. Cl. G02C 1/00

(52) U.S. Cl. 351/158

(57) ABSTRACT

A pair of eyeglasses include a rim, a first temple and a second temple, a FM receiver built in the first temple, a pair of wireless earphones respectively joined to the first and the second temples and electrically connected to the FM receiver, an LCD fitted on an outward side of the first temple, a control fitted on the first temple for controlling sound volume as well as for tuning the FM receiver with, a Blue Tooth receiving and transmitting module built in the second temple, and a microphone built in the second temple and electrically connected to the Blue Tooth receiving and transmitting module; the wireless earphones are positioned such that when one wears the eyeglasses, the wireless earphones will be near to ears of the wearer; the LCD is used to show the frequency of a channel being received through the FM receiver.

### BACKGROUND OF THE INVENTION

1. Field of the invention

The present invention relates to eyeglasses with signal receiving function, more particularly one, which are equipped with a FM receiver, a pair of wireless earphones joined to temples of the eyeglasses, a Blue Tooth receiving and transmitting module, and a microphone such that one is allowed to listen to music, and receive and transmit voice signals wirelessly by means of the eyeglasses.

2. Brief Description of the Prior Art

Some fashionable people like to wear various styles of eyeglasses to create different look and match their clothing. And, eyeglasses with radio receiving function are available, which have a radio receiver fitted to one of the temples to be used with earphones. Therefore, wearers of the eyeglasses are allowed to listen to broadcast through the radio receivers and the earphones.

With the development of modern digital products such as MP3 players and mobile phones, eyeglasses with radio receiving function are no longer considered novel. However, people have to wear earphones to listen to MP3 music, and the long wires of the earphones are prone to cause trouble to the users, which extend from MP3 players to the users' ears.

Moreover, when one person is wearing Blue Tooth earphones, which a Blue Tooth mobile phone is to be used together with, he can't wear his eyeglasses because the Blue Tooth earphones are hung on the person's ears, leaving no space for the temples of his eyeglasses. Therefore, such problem has to be overcome so that it is possible to for a person to use Blue Tooth earphones when he is wearing eyeglasses.

### SUMMARY OF THE INVENTION

It is a main object of the invention to provide a pair of eyeglasses with signal receiving function to overcome the above disadvantages.

The eyeglasses of the invention include a rim, a first temple and a second temple, a FM receiver built in the first temple, a pair of wireless earphones respectively joined to the first and the second temples and electrically connected to the FM receiver, an LCD fitted on an outward side of the first temple, a control fitted on the first temple for controlling sound volume as well as for tuning the FM receiver with, a Blue Tooth receiving and transmitting module built in the second temple, and a microphone built in the second temple and electrically connected to the Blue Tooth receiving and transmitting module. The wireless earphones are positioned such that when one wears the eyeglasses, the wireless earphones will be near to ears of the wearer. The LCD is used to show the frequency of a channel being received through the FM receiver. Therefore, one is allowed to listen to music, and receive and give voice signals wirelessly by means of the eyeglasses.

### BRIEF DESCRIPTION OF THE DRAWINGS

The present invention will be better understood by referring to the accompanying drawings, wherein:

FIG. 1 is a perspective view of the eyeglasses with signal receiving function according to the present invention,

FIG. 2 is an exploded perspective view of the wireless earphone according to the present invention,

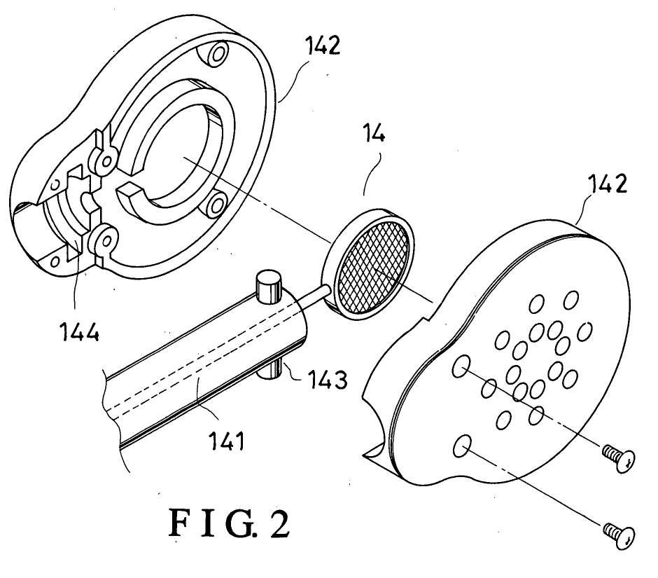

FIG. 3 is a side view of the eyeglasses in the present invention,

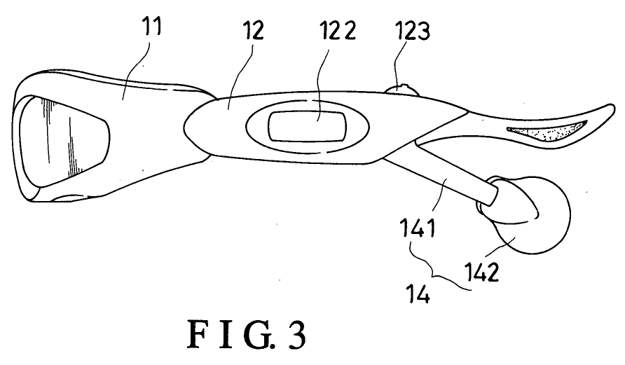

FIG. 4 is a perspective view of the eyeglasses of the invention being used in the first way, and

FIG. 5 is a perspective view of the eyeglasses of the invention being used in another way.

### DETAILED DESCRIPTION OF THE PREFERRED EMBODIMENTS

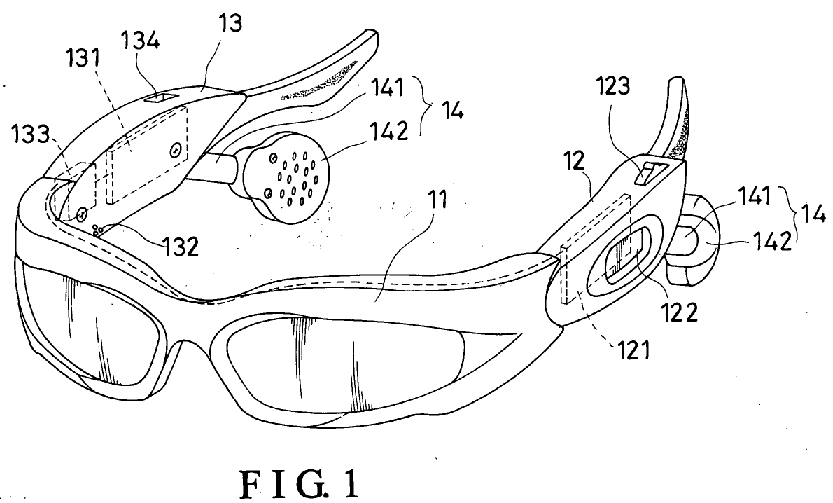

Referring to FIG. 1, a preferred embodiment of a pair of eyeglasses include a rim 11, temples 12 and 13 pivoted to the rim 11, a FM receiver 121, an LCD (liquid crystal display) 122, a switch 123, a Blue Tooth receiving and transmitting module 131, a microphone 132, a power source 133, a socket 134, and a pair of wireless earphones 14.

The wireless earphones 14 are respectively joined to the temples 12 and 13 such that when one wears the eyeglasses, the wireless earphones 14 will be near the ears of the wearer. Each of the earphones 14 includes an extension portion 141, an over-ear portion 142, and a pivotal stick 143; the extension portion 141 is connected to the corresponding temple 12 (13) at a front end; the over-ear portion 142 includes a housing, which consists of two parts 142, 142 coupled together, and which has a holding channel 144 on an inner side thereof; the pivotal stick 143 is secured on a rear end of the extension portion 141; the rear end of the extension portion 141 is held in the housing of the over-ear portion 142 with the pivotal stick 143 being held in the holding channel 144 of the over-ear portion 142 such that the over-ear portion 142 can be adjusted in the orientation in relation to the extension portion 141.

The FM receiver 121 is built in the temple 12, and used for receiving signals from a radio transmitter, which is connected to a digital music player such as a MP3 player. And, the FM receiver 121 is electrically connected to the wireless earphones 14 therefore the wearer of the eyeglasses can listen to music through the FM receiver 121 and the wireless earphones 14.

The LCD 122 is fitted on an outward side of the temple 12 for showing the frequency of a channel being received through the FM receiver 121. The control 123 is fitted on the temple 12, and used for controlling the volume as well as for tuning the FM receiver 121.

The Blue Tooth receiving and transmitting module 131 is used for receiving signals from a blue tooth mobile phone, and it is built in the temple 13, and electrically connected to the wireless earphones 14. Therefore, the wearer of the eyeglasses can hear voice signals of a blue tooth mobile phone through both the Blue Tooth receiving and transmitting module 131 and the wireless earphones 14.

The microphone 132 is built in the temple 13, and electrically connected to the Blue Tooth receiving and transmitting module 131 therefore signals can be transmitted to a blue tooth mobile phone through the microphone 132 and the Blue Tooth receiving and transmitting module 131. Furthermore, the microphone 132 is arranged in such a position as to be near to the mouth of the wearer of the eyeglasses.

The power source 133 is positioned in the temple 13, and electrically connected to both the FM receiver 121 and the Blue Tooth receiving and transmitting module 131 for providing electricity to the FM receiver 121 and the Blue Tooth receiving and transmitting module 131. The power source 133 can be a discardable battery or a rechargeable battery. The socket 134 is fitted on the temple 13 such that if a rechargeable battery is used as the power source 133, the rechargeable battery will be electrically connected to the socket 134. Consequently, the rechargeable battery will be charged when an external power source is connected to the socket 134.

Therefore, the over-ear portions 142 of the wireless earphones 14 will be over the ears of the wearer of the eyeglasses, and the microphone 132 near to the mouth of the wearer, and the wearer is allowed to adjust the position of the over-ear portions 142 of the wireless earphones 14 according to his need. And, the wearer of the eyeglasses will be allowed to use the signal receiving and transmitting functions of the eyeglasses as soon as the FM receiver 121 and the Blue Tooth receiving and transmitting module 131 are activated.

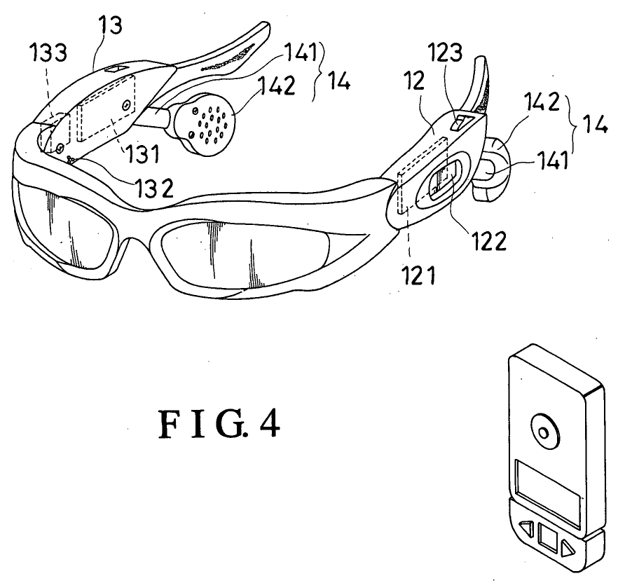

Referring to FIG. 4, after the power source 133 of the eyeglasses of the invention starts to provide electric power, the FM receiver 121 will receive signals from a single radio transmitter or a radio transmitter that has been connected to a digital music player such as a MP3 player. And, music will be played through the FM receiver 121 and the wireless earphones 14, and the LCD 122 will show the frequency of the channel being received through the FM receiver 121. And, the volume of music can be controlled, and the FM receiver 121 can be tuned by means of the control 123.

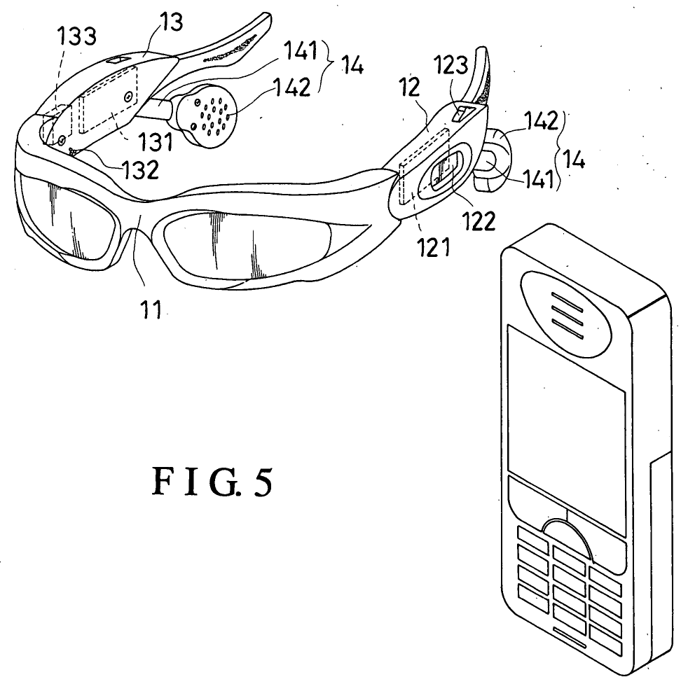

Referring to FIG. 5, after the power source 133 of the eyeglasses of the invention starts to provide electric power, the wearer of the eyeglasses can hear audio signals of a blue tooth mobile phone through both the Blue Tooth receiving and transmitting module 131 and the wireless earphones 14. And, voice signals of the wearer will be transmitted to a blue tooth mobile phone through the microphone 132 and the Blue Tooth receiving and transmitting module 131.

From the above description, it can be easily understood that the eyeglasses of the present invention has advantages as followings:

The wearer of the eyeglasses is allowed to listen to music without using a long cord, because the temples of the eyeglasses are equipped with the FM receiver, and the wireless earphones. And, because the eyeglasses are equipped with the Blue Tooth receiving and transmitting module, the microphone, and the wireless earphones, voice signals can be transmitted between the eyeglasses and a Blue Tooth mobile phone, and the wearer of the eyeglasses is allowed to talk to another person a certain distance apart from him without having to hold a phone in the hands. And, the wireless earphones can be adjusted in the orientation to suit the wearer of the eyeglasses. Therefore, the present invention is convenient and safe to use.

What is claimed is:

1. A pair of eyeglasses with signal receiving function, comprising a rim;
a first temple and a second temple pivoted to the rim;
a FM receiver built in the first temple, and used for receiving radio signals;
a pair of wireless earphones respectively joined to the first and the second temples and electrically connected to the FM receiver; the wireless earphones being positioned such that when one wears the eyeglasses, the wireless earphones will be near to ears of the wearer;
an LCD fitted on an outward side of the first temple;
a control fitted on the first temple for controlling sound volume as well as for tuning the FM receiver with;
a Blue Tooth receiving and transmitting module built in the second temple and electrically connected to the wireless earphones for receiving signals from an external Blue Tooth device as well as for transmitting signals to an external Blue Tooth device;
a microphone built in the second temple; the microphone being electrically connected to the Blue Tooth receiving and transmitting module for allowing signals to be sent to the Blue Tooth receiving and transmitting module through the microphone; and
a power source held in the second temple, and electrically connected to both the FM receiver and the Blue Tooth receiving and transmitting module.

2. The eyeglasses as claimed in claim 1, wherein each of the wireless earphones includes an extension portion, and an over-ear portion; the extension portion being connected to a corresponding temple at a first end thereof; the extension portion being passed into the over-ear portion at a second end thereof; the extension portion being connected to the over-ear portion at the second end thereof in such a way that the over-ear portion is adjustable in orientation in relation to the extension portion.

3. The eyeglasses as claimed in claim 2, wherein each of the extension portions of the wireless earphones has a pivotal stick secured to the second end thereof, and each of the over-ear portions of the wireless earphones includes a housing, which consists of two parts coupled together, and which has a holding channel on an inner side thereof; the pivotal stick being held in the holding channel of the over-ear portion such that the over-ear portion is adjustable in orientation in relation to the extension portion.

4. The eyeglasses as claimed in claim 1, wherein the power source is a discardable battery.

5. The eyeglasses as claimed in claim 1, wherein the power source is a rechargeable battery, and a socket is fitted on one of the temples for allowing the rechargeable battery to be charged through the socket.
